(19) United States
(12) Patent Application Publication
(10) Pub. No.: US 2012/0193928 A1
(43) Pub. Date: Aug. 2, 2012

(54) Towing Device For Small Planes

(76) Inventor: Jeff Schiedegger, Jupiter, FL (US)

(21) Appl. No.: 13/016,652

(22) Filed: Jan. 28, 2011

(51) Int. Cl. B66C 1/34

(52) U.S. Cl. 294/82.1

(57) ABSTRACT

The present invention is a tow device for small aircraft and the like. The tow device includes a hook or hook-like mechanism that is removably secured to the nose fork of the front wheel of an aircraft. The hook or hook-like mechanism is constructed and arranged to be easily secured to and removed from a nose fork of the front wheel of an aircraft by an individual. No tools or special equipment is required to secure the present invention to the nose fork. The hook or hook-like mechanism is designed such that by securing a rope or other towing device to one point on the hook, the wheel of the aircraft can be moved and steered in any direction. The hook or hook-like mechanism can also be coated with a material which will prevent it from slipping on the nose fork when it is pulled or moved in different directions.

### FIELD OF THE INVENTION

The present invention relates to the field of aircraft moving devices at airports and the like. In particular, the present invention relates to a hook which can be secured to a front wheel of a small plane to move the plane along the ground.

### BACKGROUND OF THE INVENTION

Moving small aircraft along the ground is frequently necessary when the aircraft needs to be serviced and when the aircraft needs to be moved into or removed from a hanger. Virtually every airport has a manual tow bar. This is usually a simple bar with a handle on one end and a pair of ears on the opposite end. The ears are designed to fit over and engage the axle of the front wheel of an aircraft. While this may be suitable for small aircraft, it will not work when larger aircraft require movement. To overcome this problem, aircraft tugs have been invented. These tugs are secured to the axle of the front wheel of a small aircraft to move the aircraft without use of the aircraft engines. However, this requires a significant investment in the cost of the tugs and the equipment required to operate the tugs. Further, it also requires having someone available to operate the tugs and/or assist in the training of small aircraft owners in the operation of these tugs.

### DESCRIPTION OF THE PRIOR ART

U.S. Pat. No. 3,946,886 discloses a tow device for a small aircraft. The device includes a winch assembly 44 which is secured to the front wheel of an aircraft. The front wheel of the aircraft is then brought up a ramp 60 onto the tow device. The tow device includes means to provide power to the wheels of the tow device so that a person can move an aircraft wherever they want. U.S. Pat. No. 4,470,564 discloses a manual aircraft tug which includes a first end secured to the axle of an aircraft and a second end which includes a handle. After the tug is secured to the axle of the aircraft, a person can then pull or push the aircraft wherever they want. This requires that the person operating the tug be relatively strong, and not many people can accomplish this. It also requires a different fitting for each different wheel axle. U.S. Pat. No. 4,915,185 discloses an aircraft moving device which comprises a portable electric drill secured to a drive shaft. The other end of the drive shaft operates a drive wheel. The drive wheel is frictionally secured to the front wheel on an aircraft by securing the device to the axle of the front wheel. Operation of the drill turns the drive wheel, which in turn turns the front wheel of the aircraft. The main drawback of this device is the short life of the battery of the portable drill. It also requires a different fitting for each different wheel axle. U.S. Pat. No. 6,942,180 discloses a tug device similar to the one disclosed in U.S. Pat. No. 4,470,564. The difference is that the portable drill operates a wheel 27 which engages the ground instead of the front wheel of an aircraft. Tow bars 33 and 37 are secured between the wheel 27 and the front axle of an aircraft. Again, the drawback to this device is the short life of the battery of the portable drill. It also requires a different fitting for each different wheel axle.

### SUMMARY OF THE INVENTION

The present invention is a tow device for small aircraft and the like. The tow device includes a hook or hook-like mechanism that is removably secured to the nose fork of the front wheel of an aircraft. The hook or hook-like mechanism is constructed and arranged to be easily secured to and removed from a nose fork of the front wheel of an aircraft by an individual. No tools or special equipment is required to secure the present invention to the nose fork. The hook or hook-like mechanism is designed such that, by securing a rope or other towing device to one point on the hook, the wheel of the aircraft can be moved and steered in any direction by means of the rope. The hook or hook-like mechanism can also be coated with a material which will prevent it from slipping on the nose fork when it is pulled or moved in different directions.

Accordingly, it is an objective of the present invention to provide a simple device which is readily securable to a front wheel of an aircraft.

It is a further objective of the present invention to provide a device which is readily securable to and removable from a front wheel of an aircraft without the use of tools.

It is yet another objective of the present invention to provide a device which is readily securable to different front wheel assemblies of aircraft without the use of special adapters.

It is a still further objective of the present invention to provide a device which is readily securable to the nose fork of a front wheel of an aircraft and enables an individual to readily manually steer the aircraft by the use of a single rope secured to the device.

It is a still further objective of the present invention to provide a device which enables an individual to move an aircraft without the use of power assisted equipment.

It is a still further objective of the present invention to provide a device which is coated with a material which prevents the device from sliding or moving when the device is secured to a nose fork of the front wheel of an aircraft and protects the nose fork finish from damage.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a top perspective view of the present invention;

FIG. 2 is an end view of the present invention;

FIG. 3 is a side view of the present invention;

FIG. 4 is a top view of the present invention without a ring;

FIG. 5 is an end view of the present invention without a ring;

FIG. 6 is a perspective view of the present invention installed on a nose fork of an aircraft; and

FIG. 7 is a perspective view of the present invention installed on a nose fork of an aircraft and securing the front wheel of the aircraft to a towing device.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

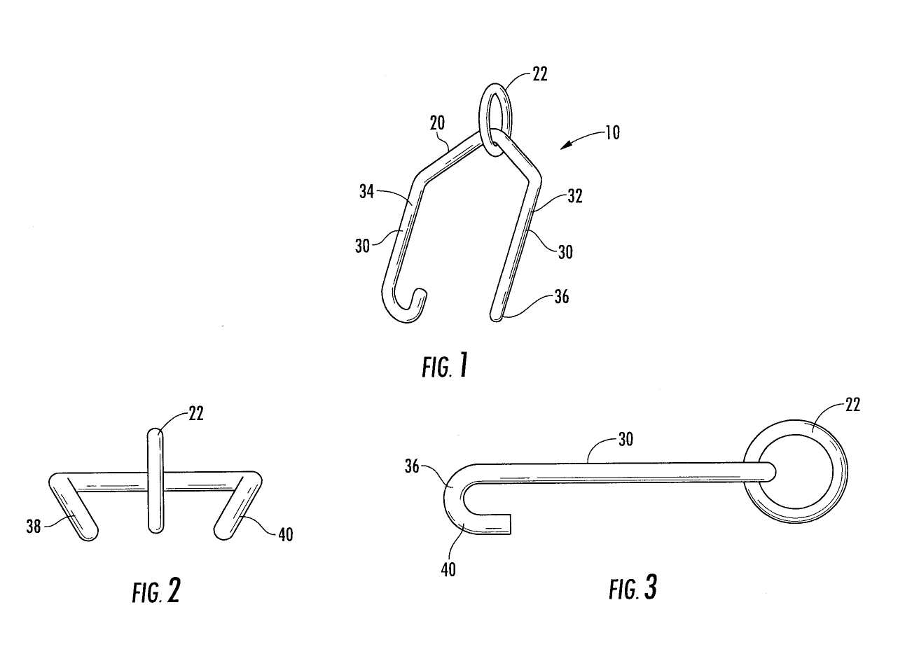

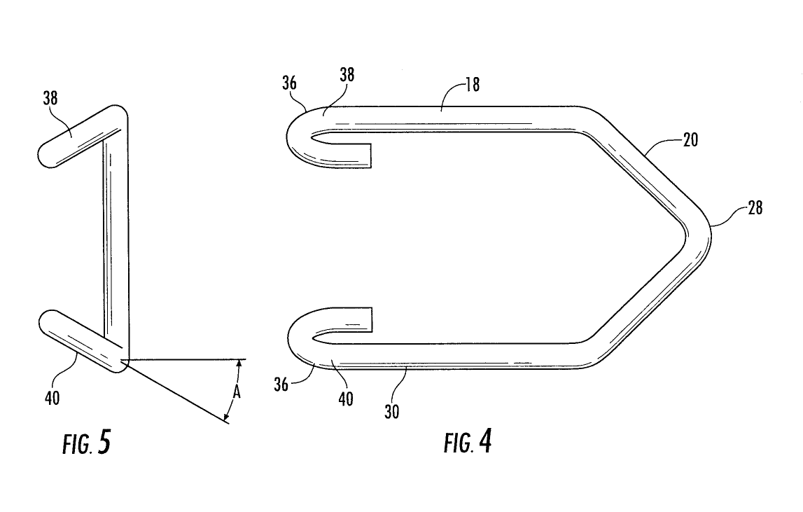

FIGS. 1-7, which are now referenced, illustrate the present invention and the manner in which it is secured to aircraft. Aircraft having a front wheel or wheels supported on an axle are suitable for use with the present invention. The present invention includes a hook or securing device 10 which is secured to the front wheel (s) of an aircraft. The aircraft can then be maneuvered to various locations.

Prior art tug devices, which are used to move aircraft, are secured to the axle of the front wheel of an aircraft. The axles of various aircraft are not standardized with respect to size or other dimensions. This presents a problem with securing devices, such as tugs, to the axles. Various adapters are required to enable the devices or tugs to be secured to the axles of various aircraft. This can become very expensive because of the many different smaller aircraft currently available. Further, many smaller airports do not have the storage space to accommodate all of the adaptors that may be required to handle all of the different aircraft which fly into and out of these airports.

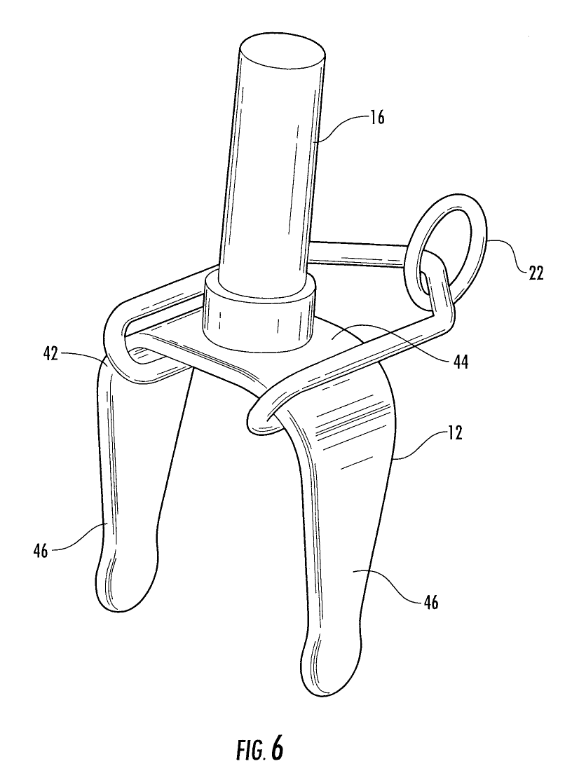

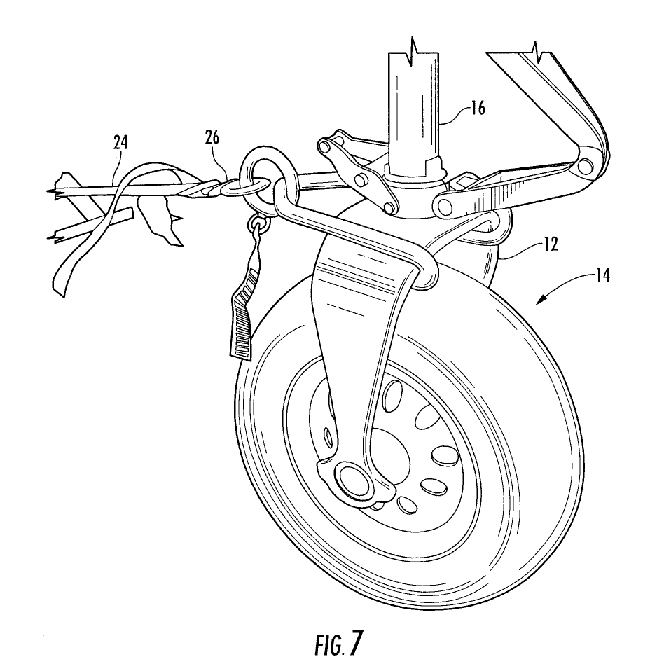

The present invention overcomes this problem by securing the device or tug to the nose fork 12 of a front wheel 14 of an aircraft (FIGS. 6 and 7). The nose fork 12 of the front wheel of an aircraft is generally an inverted U-shape. The strut of the front wheel assembly is secured to the top portion of the nose fork. This section is generally relatively flat, which enables the strut 16 to be secured thereto. The junction at which the strut 16 is secured to the nose fork 12 is usually provided with a bearing. This bearing enables the front wheel 14 to be pivoted, which in turn steers the aircraft in the direction of the wheel.

The hook or tug 10 of the present invention is generally U-shaped when viewed from above or below (FIG. 4). While this is the preferred shape, any other shape could also be employed. The hook 10 is preferably made from a cylindrical rod 18. Rods having other cross sectional shapes can also be employed. A first end 20 of the hook 10 is generally V-shaped when viewed from the top or bottom of the hook. A ring 22 is placed onto the hook 10 at the first end 20. The ring 22 enables a rope or similar device 24 to be secured to the hook 10 so that the hook can be pulled in a given direction. The rope 24 can be provided with an optional snap ring 26 which enables the rope to be quickly and easily secured to the hook 10 (FIG. 7). While it is preferred that the hook 10 be formed from a single piece of material, separate pieces of material can be joined together to form hook 10.

The V-shaped first end 20 of the hook includes a point or area 28 where the ring 22 is preferably secured to the hook. The area 28 is shaped so as to enable the ring 22 to interact with the hook 10 to pull the hook in different directions or enable directional control of the hook. The shape of area 28 enables the ring to remain at the same relative position on the hook, while the hook is pulled in different directions. By having this relationship between the ring and the hook an individual can maneuver an aircraft relatively easily. Without this relationship, the ring will move to various different positions on the hook when an individual pulls at different directions on a rope trying to maneuver an aircraft. This movement may result in the hook becoming disengaged from the aircraft wheel or doing damage to the aircraft wheel. While the preferred shape of first end 20 is a “V”, other shapes can also be employed.

A central portion 30 of the hook 10 includes two (2) substantially parallel rods 32 and 34. These rods or members 32, 34 connect a first end 20 of the hook to a second end 36 of the hook. This central portion 30 evenly distributes the pulling force generated by the ring 22 to the second end 36 of the hook. The second end 36 of the hook includes two engaging members 38 and 40. Engaging members 38 and 40 are substantially U-shaped. They are constructed and arranged to fit over and engage the upper portion of the nose fork assembly 12 of an aircraft as illustrated in FIGS. 6 and 7. The engaging members 38 and 40 are turned inwardly toward the center of the hook, as illustrated in FIGS. 1, 2, 4 and 5. The angle of inward inclination “A” is selected based on the radius of the curve 42 of the nose fork 12 between the horizontal surface 44 and the two vertical legs 46. The angle of inclination “A” is selected so that when the hook 10 is placed onto the nose fork 12, engaging members 38 and 40 engage the underside of the nose fork substantially at the center of the curve 42. This prevents the hook 10 from moving with respect to the nose fork 12, because when the hook 10 tends to move laterally in either direction, one of the engaging members 38, 40 will move into contact with one of the vertical legs 46 of the nose hook. The contact of the engaging members 38, 40 by the vertical legs will prevent further lateral movement of the hook. This is important when an individual is turning the front wheel of the aircraft to move the aircraft in a different direction. If the hook 10 becomes disengaged from the nose fork 12 while an individual is attempting to turn the aircraft, the individual must stop and reattach the hook to the aircraft. This presents many problems and is very time consuming. While the radius of curve 42 may differ somewhat from one aircraft to another, it is basically the same. Therefore, the angle of inclination “A” of engaging members 38, 40 is substantially the same for most hooks used for different aircraft. A preferred angle of inclination “A” is 30 degrees. Angles of inclination other than 30 degrees can be employed. The angle of inclination utilized depends on the radius of the curve 42. The engaging members are substantially C-shaped in a preferred embodiment. They can be formed from other shapes as long as they engage the curve of a nose fork of an aircraft.

The hook 10 is also preferably coated with a polyurethane and a polyurea elastomer such as LINE-X®. This coating serves multiple purposes. First, it helps to prevent the hook 10 from moving or sliding on the nose fork 12. Next, it prevents the hook from scratching or marring the surface of the nose fork, which is usually painted.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

1. A hook for moving aircraft having at least one front wheel mounted between two tines of an aircraft nose fork comprising:
a hook member constructed and arranged to engage the radius of a nose fork of an aircraft extending between the tines and the nose strut attachment, said hook being substantially U-shaped in a horizontal plane section, so that one tine engages said radius on each side of said nose strut attachment;
said hook including a first end, said first end being constructed and arranged to engage a connection member for applying a pulling force to said hook, said pulling force distributed to said tines to cause said nose fork to align with said force;
said tines forming a central portion and a second end of said hook, each said tine of said second end of said hook including a C-shaped hook, each said C-shaped hook extending below said horizontal plane, each said C-shaped hook having an inward angle of inclination with respect to an orthogonal plane of said hook member to engage said radius at an angle that is substantially perpendicular with respect to the point of contact with said radius, whereby the aircraft is moved in the direction of the force.

2. The device of claim 1 wherein said first end of said hook is substantially V-shaped.

3. The device of claim 1 wherein said hook is formed from a single piece of material.

4. The device of claim 3 wherein said material is substantially circular in cross section.

5. (canceled)

6. (canceled)

7. (canceled)

8. The device of claim 1 wherein said hook is coated with a polyurethane material.

9. The device of claim 1 wherein said connection member is a ring.

10. The device of claim 1 wherein said hook is secured to a nose fork without the use of tools.
